(19) United States
(12) Patent Application Publication
(10) Pub. No.: US 2026/0007245 A1
(43) Pub. Date: Jan. 8, 2026

(54) ANGLE-ADJUSTABLE SUPPORT STRUCTURE AND ADJUSTABLE BED THEREWITH

(71) Applicant: Nisco Co., Ltd, Rugao (CN)

(72) Inventors: Wei Wang, Rugao (CN); Fahuan Zhang, Rugao (CN); Jian Xie, Rugao (CN)

(21) Appl. No.: 19/260,743

(22) Filed: Jul. 7, 2025

Related U.S. Application Data
(60) Provisional application No. 63/706,069, filed on Oct. 11, 2024.

(30) Foreign Application Priority Data
Jul. 5, 2024 (CN) 202421593615.5

(51) Int. Cl. A47C 20/04; A61G 7/015; A61G 7/018

(52) U.S. Cl. CPC A47C 20/041; A61G 7/015; A61G 7/018

(57) ABSTRACT

An angle-adjustable support structure and an adjustable bed incorporating the same are disclosed. The support structure comprises a base frame, a support frame, front and rear link mechanisms, and front and rear actuators. The support frame is pivotally connected to the base frame via the front and rear link mechanisms and is driven by the front and rear actuators to tilt at multiple angles, including a horizontal position. The adjustable bed further includes a bed frame mounted on the support frame and a mattress platform composed of articulated panels. Additional actuators enable independent tilting of the backrest and leg sections of the mattress platform. The combined operation of the tilting support structure and articulating panels enables improved ergonomic comfort and enhanced suitability across various usage scenarios such as sleep, therapy, and patient care.

### CROSS-REFERENCE TO RELATED PATENT APPLICATIONS

This application claims priority to and the benefit of U.S. Provisional Patent Application Serial No. 63/706,069 filed October 11, 2024, which is incorporated herein in its entirety by reference.

This application claims priority to and benefit of Chinese Patent Application Serial Nos. 202421593615.5, filed July 5, 2024, which is incorporated herein in its entirety by reference.

### FIELD OF THE INVENTION

The invention generally relates to a bed, and more particularly to an angle-adjustable support structure and adjustable bed utilizing the angle-adjustable support structure.

### BACKGROUND OF THE INVENTION

Adjustable beds are increasingly used in healthcare, rehabilitation, and residential environments due to their ability to adjust body posture for comfort or medical purposes. Conventional adjustable beds typically adjust only the backrest or legrest portions of the mattress, limiting their ability to accommodate diverse user needs. This constrained adjustment range reduces ergonomic effectiveness and prevents optimal support for different scenarios, such as medical treatment, sleeping, reading, or caregiving.

Therefore, there is a need for an adjustable bed system that offers more comprehensive and flexible posture adjustments.

### SUMMARY OF THE INVENTION

This invention aims to address the shortcomings of traditional adjustable beds by introducing an angle-adjustable support structure that allows the entire bed frame to tilt at various angles. In addition, the adjustable bed incorporates this support structure and features a multi-segment mattress platform with independent actuators for localized adjustments.

In one aspect, this invention relates to an angle-adjustable support structure comprising a base frame, and a support frame disposed above the base frame, each frame having a front portion and a rear portion; a front support link mechanism having a first end and a second end pivotally connected to the front portions of the base frame and the support frame, respectively; a rear support link mechanism having a first end and a second end pivotally connected to the rear portions of the base frame and the support frame, respectively; and a front actuator pivotally connected between the support frame and the front support link mechanism; a rear actuator pivotally connected between the support frame and the rear support link mechanism, wherein the front actuator and the rear actuator are configured to drive the corresponding link mechanisms to tilt the support frame at multiple angles including a horizontal position.

In one embodiment, the front support link mechanism comprises a pair of front link arms and a front support beam connecting the pair of front link arms, and the front actuator is pivotally connected to the front support beam.

In one embodiment, the front actuator comprises an electric push rod having a fixed end pivotally connected to the front end of the support frame, and an extendable end pivotally connected to the front support beam of the front support link mechanism.

In one embodiment, the front actuator comprises an electric push rod having a fixed end pivotally connected to the front support beam of the front support link mechanism, and an extendable end pivotally connected to the front end of the support frame.

In one embodiment, the rear support link mechanism comprises a pair of first rear link arms and a rear support beam connecting the pair of first rear link arms, and the rear actuator is pivotally connected to the rear support beam.

In one embodiment, the rear support link mechanism further comprises a pair of second rear link arms, each second rear link arm having a first end and a second end pivotally connected to the base frame and a mid-portion of a corresponding one of the pair of first rear link arms, respectively, thereby forming a triangular structure for enhanced load-bearing stability.

In one embodiment, the rear actuator comprises an electric push rod having a fixed end pivotally connected to the rear end of the support frame, and an extendable end pivotally connected to the rear support beam of the rear support link mechanism.

In one embodiment, the rear actuator comprises an electric push rod having a fixed end pivotally connected to the rear support beam of the rear support link mechanism, and an extendable end pivotally connected to the rear end of the support frame.

In another aspect, the invention relates to an adjustable bed comprising the angle- adjustable support structure as disclosed above; a bed frame disposed on the support frame such that the bed frame co-moves together with the support frame, the bed frame having a front portion and a rear portion; a mattress platform disposed on the bed frame, the mattress platform comprising a back panel and a front seat panel pivotally connected to the back panel, wherein the front seat panel is fixed on the front portion of the bed frame; a front tilt actuator pivotally connected between the front portion of the bed frame and the back panel, configured to tilt the back panel relative to the front seat panel into multiple positions including horizontal.

In one embodiment, the mattress platform further comprise a rear seat panel fixed on the rear portion of the bed frame, and a leg panel pivotally connected to the rear seat panel.

In one embodiment, the adjustable bed further comprises a rear tilt actuator pivotally connected between the rear portion of the bed frame and the leg panel, configured to tilt the leg panel relative to the rear seat panel.

In one embodiment, the leg panel comprises a thigh panel pivotally connected to the rear seat panel, and a calf panel pivotally connected to the thigh panel, and the rear tilt actuator is pivotally connected to the calf panel.

In one embodiment, the adjustable bed further comprises a link rod having a first end pivotally connected to the rear portion of the bed frame, and a second end pivotally connected to the calf panel to provide additional structural support during tilting.

In one embodiment, the bed frame comprises a front bed frame and a rear bed frame that are pivotally connected and configured to fold together, allowing the adjustable bed to be folded for compact storage and transport.

According to the invention, the angle-adjustable support structure and the adjustable bed have the following beneficial effects: when the angle-adjustable support structure is in use, the front actuator and the rear actuator respectively drive the front support link mechanism and the rear support link mechanism to move, thereby driving the support frame to flip along the hinges with the front support link mechanism and the rear support link mechanism, to achieve a variety of angles including horizontal angles.

The adjustable bed incorporates the angle-adjustable support structure. Firstly, the support structure plays the role of lifting the bed frame to replace the bed posts. Secondly, when the support frame flips, it drives the bed frame to flip together. The support frame enables the bed frame to position in a variety of angles including the horizontal angle. On this basis, the bed frame itself can also flip through the front tilt actuator to drive the back panel to flip along the hinged end with the front seat panel, thereby driving the back panel in a variety of angles/states including a horizontal angle/state. The combination of these two action mechanisms greatly enriches the postures that the adjustable bed can provide, not only providing a more comfortable experience, but also providing richer usage scenarios, which solves the problem that the adjustable bed in the prior art can only adjust the posture by adjusting the backrest and legrest and cannot meet users' higher demands for comfort and usage scenarios.

These and other aspects of the invention will become apparent from the following description of the preferred embodiment taken in conjunction with the following drawings, although variations and modifications therein may be affected without departing from the spirit and scope of the novel concepts of the invention.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment.

FIG. 1 shows schematically an exploded perspective view of an adjustable bed with an angle-adjustable support structure according to one embodiment of the invention.

FIG. 2 shows schematically a s perspective view of the adjustable bed in an assembled and operating state.

### DETAILED DESCRIPTION OF THE INVENTION

The invention will now be described more fully hereinafter with reference to the accompanying drawings, in which exemplary embodiments of the invention are shown. The invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting and/or capital letters has no influence on the scope and meaning of a term; the scope and meaning of a term are the same, in the same context, whether or not it is highlighted and/or in capital letters. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only and in no way limits the scope and meaning of the invention or of any exemplified term. Likewise, the invention is not limited to various embodiments given in this specification.

The terminology used herein is for the purpose of describing particular embodiments only and is not intended to be limiting of the invention. As used herein, the singular forms "a," "an," and "the" are intended to include the plural forms as well, unless the context clearly indicates otherwise.

It will be understood that when an element is referred to as being "on," "attached" to, "connected" to, "coupled" with, "contacting," etc., another element, it can be directly on, attached to, connected to, coupled with or contacting the other element or intervening elements may also be present. In contrast, when an element is referred to as being, for example, "directly on," "directly attached" to, "directly connected" to, "directly coupled" with or "directly contacting" another element, there are no intervening elements present. It will also be appreciated by those of skill in the art that references to a structure or feature that is disposed "adjacent" to another feature may have portions that overlap or underlie the adjacent feature.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below can be termed a second element, component, region, layer or section without departing from the teachings of the invention.

Furthermore, relative terms, such as "lower" or "bottom" and "upper" or "top", and "front" and "rear" maybe used herein to describe one element's relationship to another element as illustrated in the figures. It will be understood that relative terms are intended to encompass different orientations of the device in addition to the orientation shown in the figures. For example, if the device in one of the figures is turned over, elements described as being on the "lower" side of other elements would then be oriented on the "upper" sides of the other elements. The exemplary term "lower" can, therefore, encompass both an orientation of lower and upper, depending on the particular orientation of the figure. Similarly, if the device in one of the figures is turned over, elements described as "below" or "beneath" other elements would then be oriented "above" the other elements. The exemplary terms "below" or "beneath" can, therefore, encompass both an orientation of above and below.

It will be further understood that the terms "comprise(s)" and/or "comprising," or "include(s)" and/or "including" or "has (have)" and/or "having" or "contain(s)" and/or "containing" when used in this specification specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

As used herein, "around," "about," "substantially" or "approximately" shall generally mean within 20 percent, preferably within 10 percent, and more preferably within 5 percent of a given value or range. Numerical quantities given herein are approximate, meaning that the terms "around," "about," "substantially" or "approximately" can be inferred if not expressly stated.

As used in this specification, the term "board" or "platform" refers to a bed board or a bed panel.

As used in this specification, the phrase "at least one of A, B, and C" should be construed to mean a logical (A or B or C), using a non-exclusive logical OR. As used herein, the term "and/or" includes any and all combinations of one or more of the associated listed items.

The description below is merely illustrative in nature and is in no way intended to limit the invention, its application, or uses. The broad teachings of the invention can be implemented in a variety of forms. Therefore, while this invention includes particular examples, the true scope of the invention should not be so limited since other modifications will become apparent upon a study of the drawings, the specification, and the following claims. For purposes of clarity, the same reference numbers will be used in the drawings to identify similar elements. It should be understood that one or more steps within a method may be executed in different order (or concurrently) without altering the principles of the invention.

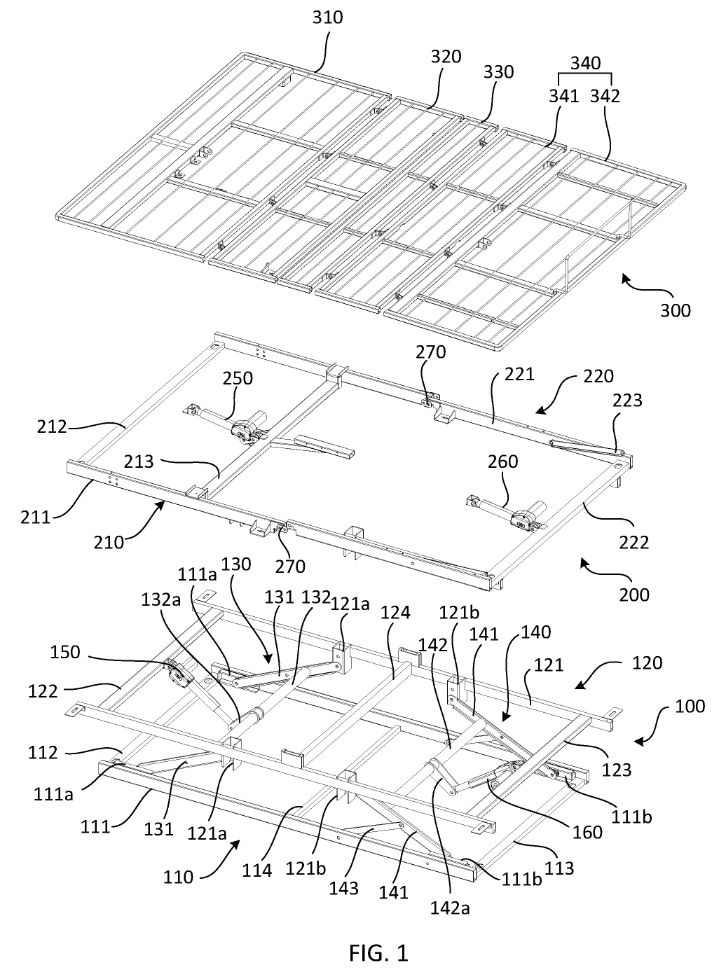

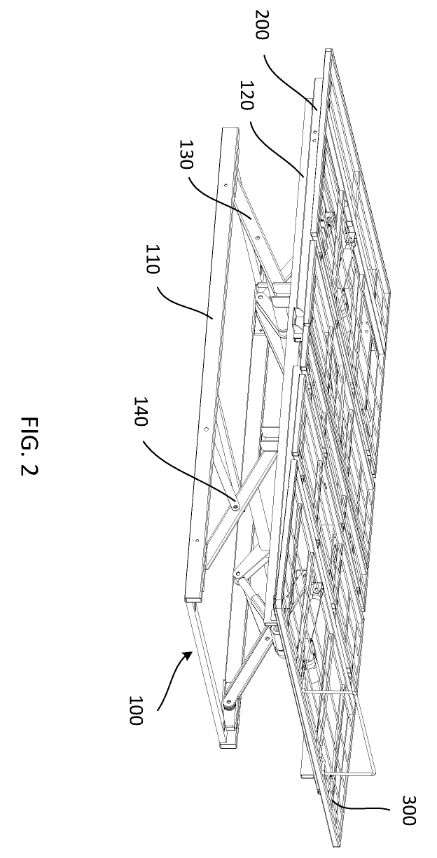

The description will be made as to the embodiments of the invention in conjunction with the accompanying drawings in FIGS. 1-2. In accordance with the purposes of this invention, as embodied and broadly described herein, this invention, in one aspect, relates to an angle- adjustable support structure and an adjustable bed incorporating the same. The angle-adjustable support structure comprises a base frame, a support frame, front and rear link mechanisms, and corresponding actuators. The support frame is pivotally connected to the base frame via the front and rear link mechanisms and is driven by the actuators to tilt at multiple angles, including a horizontal position. The adjustable bed, in addition of angle-adjustable support structure, further includes a bed frame mounted on the support frame and a mattress platform composed of articulated panels. Additional actuators enable independent tilting of the back and leg panels of the mattress platform. This configuration enables synchronized or independent adjustment of the full bed angle and localized posture, improving user comfort and expanding functionality across multiple use cases. The combined operation of the tilting support structure and the articulated panels enables improved ergonomic comfort and enhanced suitability across various usage scenarios such as sleep, therapy, and patient care.

The angle-adjustable support structure and an adjustable bed incorporating the angle- adjustable support structure are designed to overcome the limitations of conventional adjustable beds. The novel concept is to enable the entire support frame (beneath the mattress platform) to tilt in multiple angles, including horizontal, by means of the front and rear support link mechanisms driven by the actuators, such as electric push rods.

Among other things, the invention exhibits the following unique features:

Structural Innovation: Introducing a multi-angle tiltable support structure controlled by front and rear link arms driven by actuators - not present in the existing adjustable beds.

Support Frame Tilting Mechanism: Unlike existing beds that only adjust individual panels, this design allows the entire support frame and bed platform to tilt as a unit, offering full- body angle adjustments.

Triangular Rear link arm Support: The rear support linkage includes secondary linkages (link arms) forming a triangle with the first rear link arms and the base frame, which enhances load-bearing and structural stability. The rear support's triangular design provides improved mechanical stability, especially under dynamic loads during tilting.

Dual Mechanism Synergy: The bed combines two actuation systems, with one to tilt the full frame, and another to articulate panels (back, thigh, leg), enabling multi-directional and compound posture adjustments. A coordinated system where both the support frame and panels move independently and cooperatively to achieve richer posture configurations.

Foldable Bed Frame for Storage: The bed frame can be folded for compact storage and transport, reducing packaging size and logistics cost. The foldable frame design allows compact storage and cost-effective transport, which is especially valuable in commercial or institutional environments.

Improved Versatility and Usability: The system supports a wider range of postures and multi-scene applicability, from sleeping and resting to therapy and patient care, exceeding conventional single-function adjustable beds.

This invention provides a highly ergonomic, structurally stable, and versatile adjustable bed, representing a significant improvement over prior solutions by enabling richer posture variations, better comfort, and broader usage scenarios.

Without intent to limit the scope of the invention, exemplary embodiments of the invention are given below.

Referring to FIGS. 1-2, the angle-adjustable support structure 100 comprises a base frame 110, and a support frame 120 disposed above the base frame 110. Each of the base frame 110 and the support frame 120 and a front portion and a rear portion extending from the front portion. It should be noted that relative terms, "front" and "rear", used herein, refer to one element's relationship to another element as illustrated in FIGS. 1-2, which correspond to the left-hand side and the right-hand side of the figures, respectively. It will be understood that relative terms are intended to encompass different orientations of the device in addition to the orientation shown in the figures.

The angle-adjustable support structure 100 also comprises a front support link mechanism 130 having a first end pivotally connected to the front portion of the base frame 110 and a second end pivotally connected to the front portion of the support frame 120; and a front actuator 150 pivotally connected between the support frame 120 and the front support link mechanism 130.

The angle-adjustable support structure 100 further comprises a rear support link mechanism 140 having a first end pivotally connected to the rear portion of the base frame 110 and a second end pivotally connected to the rear portion of the support frame 120; and a rear actuator 160 pivotally connected between the support frame 110 and the rear support link mechanism 140.

The front actuator 150 and the rear actuator150 are configured to respectively drive the front and rear link mechanisms 130 and 140 to tilt the support frame 120 at multiple angles including a horizontal position.

In operation, the front actuator 150 and the rear actuator 160 respectively drive the front support link mechanism 130 and the rear support link mechanism 140 to move, thereby driving the support frame 120 to flip along the hinges with the front support link mechanism 130 and the rear support link mechanism 140 in a variety of angles including the horizontal angle.

In one embodiment, each of the front actuator 150 and the rear actuator 160 is an electric push rod or linear actuator having a fixed end and an extendable (telescopic) end, which converts the rotational motion of the motor into linear reciprocating motion for extending and retracting the extendable end.

In one embodiment shown in FIG. 1, the base frame 110 and the support frame 120 are both rectangular frame structures. The base frame 110 includes a pair of side base rails 111, a front base rail 112, a rear base rail 113 and a base connecting rod 114. The pair of side base rails 111, the front base rail 112 and the rear base rail 113 enclose a rectangular frame structure, and the base connecting rod 114 is arranged in the middle of the rectangular frame structure and connected to the pair of side base rails 111. It should be noted that the connections between the side base rails 111, the front base rail 112, the rear base rail 113 and the base connecting rod 114 can be achieved by any fixed connection means such as welding means, molding means, screwing means, mating connections, or the likes.

The support frame 120 includes a pair of supporting side rails 121, a front support rail 122, a rear support rail 123 and a support connecting rod 124. The pair of supporting side rails 121, the front support rail 122 and the rear support rail 123 enclose a rectangular frame structure, the support connecting rod 124 is arranged in the middle of the rectangular frame structure and connected to the pair of supporting side rails 121. It should be noted that the connections between the side support rails 121, the front support rail 222, the rear support rail 123 and the support connecting rod 124 can be achieved by any fixed connection means such as welding means, molding means, screwing means, mating connections, or the likes.

The front support link mechanism 130 includes a pair of front link arms 131 and a front support beam 132 connecting the pair of front link arms 131 in a H shaped structure. The first ends of the pair of front link arms 131 are respectively hinged to the pair of side base rails 111 of the base frame 110 at its front portion, directly or via brackets 111a on the pair of side base rails 111, while the second ends of the pair of front link arms 131 are respectively hinged to the pair of side support rails 121 of the support frame 120 at its front portion, directly or via brackets 121a on the pair of side support rails 121.

The front actuator 150 is pivotally connected to the front support beam 132 of the front support link mechanism 130. In one embodiment shown in FIG. 1, the front actuator 150 is an electric push rod having the fixed end pivotally connected to the front support rail 122 of the support frame 120 and the extendable end pivotally connected to the front support beam 132 of the front support link mechanism 130, directly or via a bracket 132a on the front support beam 132. In another embodiment, the fixed end and the extendable end of the front actuator 150 can be respectively hinged to the front support beam 132 of the front support link mechanism 130 and the front support rail 122 of the support frame 120. In operation, the extension and retraction of the extendable end of the front actuator 150 drive the support frame 120, and the front portion of the support frame 120, to lift or tilt at different positions including a horizontal position.

The rear support link mechanism 140 includes a pair of first rear link arms 141 and a rear support beam 142 connecting the pair of first rear link arms 141 in a H shaped structure. The first ends of the pair of first rear link arms 141 are respectively hinged to the pair of side base rails 111 of the base frame 110 at its rear portion, directly or via brackets 11 lb on the pair of side base rails 111, while the second ends of the pair first rear link arms 141 are respectively hinged to the pair of side support rails 121 of the support frame 120 at its rear portion, directly or via brackets 121b on the pair of side support rails 121.

The rear actuator 160 is pivotally connected to the rear support beam 142 of the rear support link mechanism 140. In one embodiment shown in FIG. 1, the rear actuator 160 is an electric push rod having the fixed end pivotally connected to the rear support rail 123 of the support frame 120 and the extendable end pivotally connected to the rear support beam 142 of the rear support link mechanism 140, directly or via a bracket 142a on the rear support beam 142. In another embodiment, the fixed end and the extendable end of the rear actuator 160 can be respectively hinged to the rear support beam 142 of the rear support link mechanism 140 and the rear support rail 123 of the support frame 120. In operation, the extension and retraction of the extendable end of the rear actuator 160 drive the support frame 120, and the rear portion of the support frame 120, to lift or tilt at different positions including a horizontal position.

According to the invention, the front and rear actuators 150 and 160 can operate independently or cooperatively, so that the front and rear portion of the support frame 120 can be lifted/tilted independently or cooperatively, thereby providing compound movement for customized posture control to achieve desirable angles/postures of the support frame 120 relative to the base frame 110.

In one embodiment, as shown in FIG. 1, the rear support link mechanism 140 also includes a pair of second rear link arms 143. The first ends of the pair of second rear link arms 143 are respectively hinged to the pair of the side base rails 111 at its rear portion, while the second ends are respectively hinged to the middle portions of the pair of first rear link arms 141 to bear the radial load of a part of the pair of first rear link arms 141. The first rear link arm 141, the second rear link arm 143, and the side base rail 111 form a triangular structure, thereby providing better support.

Still referring to FIGS. 1-2, the adjustable bed includes the angle-adjustable support structure 100; a bed frame 200 disposed on the support frame 120, configured to co-move with the angle-adjustable support structure 100 together; a mattress platform 300 disposed on the bed frame 200, comprising a back panel 310 and a front seat panel 320 pivotally connected to the back panel 310, the front seat panel 320 being fixed on the front portion of the bed frame 200; and a front tilt actuator 250 pivotally connected between the front portion of the bed frame 200 and the back panel 310 of the mattress platform 300, configured to tilt the back panel 310 relative to the front seat panel 320 into multiple positions (angles) including the horizontal position.

In one embodiment, the bed frame 200 includes a front bed frame 210 and a rear bed frame 220. The front bed frame 210 is a frame structure surrounded by a pair of front side rails 211 and a front cross beam 212. The rear bed frame 220 is a frame structure surrounded by two rear side rails 221 and a rear cross beam 222. The two front side rails 211 and the rear side rails 221 are hinged to each other. A front connecting beam 213 is also provided on the front bed frame 210 and arranged in the middle portion of the front bed frame 210. The two ends of the front connecting beam 213 are respectively connected to the two front side rails 211.

In one embodiment, the mattress platform 300 further comprise a rear seat 330 panel fixed on the rear portion of the bed frame 200, and a leg panel 340 pivotally connected to the rear seat panel 330. In one embodiment, the leg panel 340 has a thigh panel 341 pivotally connected to the rear seat panel 330, and a calf panel 342 pivotally connected to the thigh panel 341.

The adjustable bed further comprises a rear tilt actuator 260 pivotally connected between the bed frame 200 and the leg panel 340.

In one embodiment, each of the front tilt actuator 250 and the rear tilt actuator 260 is an electric push rod. The front tilt actuator 250 has its fixed end hinged to the front traverse rail 213 of the bed frame 200 at the front portion and its extendable end hinged to the back panel 310. In operation, the extension and retraction of the extendable end of the front tilt actuator 250 drive the back panel 310 to flip at different angles/positions including a horizontal position.

The rear tilt actuator 260 has its fixed end hinged to the rear traverse rail 222 of the bed frame 200 and its extendable end hinged to the calf panel 342. In operation, the extension and retraction of the extendable end of the rear tilt actuator 260 drive the calf panel 342, therefore, the thigh panel 341, to flip at different angles/positions including a horizontal position.

In such an arrangement, the front and rear tilt actuators 250 and 260 enable the back and leg panels to tilt independently of the entire bed frame 200, providing compound movement for customized posture control.

In one embodiment, the bed frame 200 has a link rod 223 having a first end pivotally connected to the side rails 221 of the bed frame 200 at the rear portion, and a second end pivotally connected to the calf panel 342 to provide additional structural reinforcement during tilting.

In addition, the bed frame 200 is formed of the front bed frame 210 and the rear bed frame 220 pivotally connected to the front bed frame 210 via foldable connectors 270. The front bed frame 210 and the rear bed frame 220 can be folded around the foldable connectors 270 for space-saving storage and transport. When the bed frame 200 is folded, the mattress platform 300 disposed on the bed frame 200 is also folded accordingly, so that the occupied space of the adjustable bed can be reduced, and the logistics cost can be reduced.

According to the invention, first, the angle-adjustable support structure 100 plays a role in lifting the bed frame 200 to replace the bed posts. Secondly, when the support frame 120 is lifted/tilted, it drives the bed frame 200 to lift/tilt together. The support frame 120 enables the bed frame 200 to position in a variety of angles including a horizontal angle. On this basis, the bed frame 200 itself can also drive the bed panel 310 to flip along the hinged end with the front seat panel 320 through the front tilt actuator 250, driving the bed panel 310 to be in a variety of states including a horizontal state. The combination of these two action mechanisms greatly enriches the postures that the adjustable bed can provide, not only providing a more comfortable experience, but also providing more abundant usage scenarios, which solves the problem that the adjustable bed in the prior art can only adjust the posture by adjusting the backrest and legrest and cannot meet users' higher demands for comfort and usage scenarios.

In sum, the angle-adjustable support structure and the adjustable bed provide the following advantages:

Enhanced Angle Adjustability: The supporting structure allows the bed to adjust to multiple angles, including horizontal, via both front and rear link mechanisms. This enables greater posture flexibility, surpassing traditional beds that only adjust back and leg angles.

Improved Structural Stability: Uses a triangular linkage structure in the rear support to improve load-bearing stability and safety. The bed frame and support frame are both rectangular, ensuring solid and durable construction.

Efficient and Precise Drive Mechanism: Equipped with electric push rods for front and rear actuators, providing high-efficiency, precise adjustment. Enables smooth and silent angle transitions.

Highly Customizable Postures: Dual adjustment systems: one for entire bed frame tilting, and another for independent back and leg section movement, allowing rich combinations of user postures.

Increased Comfort: Users can easily achieve their preferred ergonomic positions, which improves comfort for sleeping, reading, watching TV, or medical recovery.

Broader Usage Scenarios: Adaptable for medical, elderly care, rehabilitation, and smart home environments. Satisfies varied needs of patients, elderly, and general users alike.

Space-saving and Cost-efficient Storage: The bed frame can be folded, minimizing its size for easier transportation and reduced shipping/storage costs.

Integrated Design for Leg Support: The two-part leg panel (thigh and calf) design provides natural and supportive leg posture, improving circulation and comfort.

Stable and Safe User Support: The rear double-link structure shares radial loads, reinforcing the safety and reliability of the structure.

Industrial Applicability: The system design is modular and manufacturable, with clear commercial potential in homecare, hospital, and luxury smart furniture markets.

This invention solves the limitations of traditional adjustable beds that could only adjust certain fixed parts, offering a comprehensive and intelligent posture control solution with high comfort, adaptability, and market potential.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the invention pertains without departing from its spirit and scope. Accordingly, the scope of the invention is defined by the appended claims rather than the foregoing description and the exemplary embodiments described therein.

What is claimed is:

1. An angle-adjustable support structure, comprising:
a base frame, and a support frame disposed above the base frame, each frame having a front portion and a rear portion;
a front support link mechanism having a first end and a second end pivotally connected to the front portions of the base frame and the support frame, respectively;
a rear support link mechanism having a first end and a second end pivotally connected to the rear portions of the base frame and the support frame, respectively; and
a front actuator pivotally connected between the support frame and the front support link mechanism;
a rear actuator pivotally connected between the support frame and the rear support link mechanism,
wherein the front actuator and the rear actuator are configured to drive the corresponding link mechanisms to tilt the support frame at multiple angles including a horizontal position.

2. The angle-adjustable support structure of claim 1, wherein the front support link mechanism comprises a pair of front link arms and a front support beam connecting the pair of front link arms, and the front actuator is pivotally connected to the front support beam.

3. The angle-adjustable support structure of claim 2, wherein the front actuator comprises an electric push rod having a fixed end pivotally connected to the front end of the support frame, and an extendable end pivotally connected to the front support beam of the front support link mechanism.

4. The angle-adjustable support structure of claim 2, wherein the front actuator comprises an electric push rod having a fixed end pivotally connected to the front support beam of the front support link mechanism, and an extendable end pivotally connected to the front end of the support frame.

5. The angle-adjustable support structure of claim 1, wherein the rear support link mechanism comprises a pair of first rear link arms and a rear support beam connecting the pair of first rear link arms, and the rear actuator is pivotally connected to the rear support beam.

6. The angle-adjustable support structure of claim 5, wherein the rear support link mechanism further comprises a pair of second rear link arms, each second rear link arm having a first end and a second end pivotally connected to the base frame and a mid-portion of a corresponding one of the pair of first rear link arms, respectively, thereby forming a triangular structure for enhanced load-bearing stability.

7. The angle-adjustable support structure of claim 5, wherein the rear actuator comprises an electric push rod having a fixed end pivotally connected to the rear end of the support frame, and an extendable end pivotally connected to the rear support beam of the rear support link mechanism.

8. The angle-adjustable support structure of claim 5, wherein the rear actuator comprises an electric push rod having a fixed end pivotally connected to the rear support beam of the rear support link mechanism, and an extendable end pivotally connected to the rear end of the support frame.

9. An adjustable bed, comprising:
the angle-adjustable support structure of claim 1;
a bed frame disposed on the support frame such that the bed frame co-moves together with the support frame, the bed frame having a front portion and a rear portion;
a mattress platform disposed on the bed frame, the mattress platform comprising a back panel and a front seat panel pivotally connected to the back panel, wherein the front seat panel is fixed on the front portion of the bed frame;
a front tilt actuator pivotally connected between the front portion of the bed frame and the back panel, configured to tilt the back panel relative to the front seat panel into multiple positions including horizontal.

10. The adjustable bed of claim 9, wherein the mattress platform further comprise a rear seat panel fixed on the rear portion of the bed frame, and a leg panel pivotally connected to the rear seat panel.

11. The adjustable bed of claim 10, further comprising a rear tilt actuator pivotally connected between the rear portion of the bed frame and the leg panel, configured to tilt the leg panel relative to the rear seat panel.

12. The adjustable bed of claim 11, wherein the leg panel comprises a thigh panel pivotally connected to the rear seat panel, and a calf panel pivotally connected to the thigh panel, and the rear tilt actuator is pivotally connected to the calf panel.

13. The adjustable bed of claim 12, wherein the bed frame comprises a link rod having a first end pivotally connected to the rear portion of the bed frame, and a second end pivotally connected to the calf panel to provide additional structural support during tilting.

14. The adjustable bed of claim 9, wherein the bed frame comprises a front bed frame and a rear bed frame that are pivotally connected and configured to fold together, allowing the adjustable bed to be folded for compact storage and transport.
‎
